(19) United States
(12) Patent Application Publication
(10) Pub. No.: US 2011/0316645 A1
(43) Pub. Date: Dec. 29, 2011

(54) STEP ATTENUATOR APPARATUS

(75) Inventor: Hiroaki TAKEUCHI, Tokyo (JP)

(73) Assignee: ADVANTEST CORPORATION, Tokyo (JP)

(21) Appl. No.: 13/161,850

(22) Filed: Jun. 16, 2011

(30) Foreign Application Priority Data
Jun. 29, 2010 (JP) 2010147777

(51) Int. Cl. H01P 1/22

(52) U.S. Cl. 333/101

(57) ABSTRACT

A step attenuator apparatus is provided, having an attenuation ratio which is switchable according to a control signal. Multiple variable attenuators are connected in series. Each variable attenuator includes a first terminal, a second terminal, multiple paths having different attenuation ratios, a first switch that can be connected to one end of a desired path selected from among the multiple paths, and a second switch that can be connected to the other end of a desired path selected from among the multiple paths. When a control signal is an instruction to set the step attenuator apparatus to a disconnected state, a control unit connects the first switch of the first-stage variable attenuator to one of the multiple paths, and connects the second switch of the first-stage variable attenuator to a different one of the multiple paths.

### BACKGROUND OF THE INVENTION

1. Field of the Invention

The present invention relates to a step attenuator apparatus.

2. Description of the Related Art

A step attenuator apparatus is known wherein the overall attenuation amount is switchable by switching the internal path by means of switches. FIG. 1 is a circuit diagram which shows a configuration of a typical step attenuator apparatus. A step attenuator apparatus 1100 includes multiple variable attenuators VA₁ through VAₙ connected in series.

Each variable attenuator VA includes multiple paths PT1 and PT2 and switches SW1 through SW2. The paths PT1 and PT2 have different attenuation ratios. For example, the path PT1 has an attenuation ratio of 0 dB (through path), and the path PT2 has a non-zero attenuation ratio (20 dB).

With such an attenuator apparatus 1100, the two switches SW1 and SW2 included in the same variable attenuator VA can only be connected to the same path PT. Accordingly, with the attenuator apparatus 1100 shown in FIG. 1, the maximum attenuation ratio (20 dB×n) is provided between the input terminal IN and the output terminal OUT. In a case in which the number of steps n is insufficient, it is difficult to completely disconnect the path between (turn off the connection between) the input terminal IN and the output terminal OUT. Here, the disconnected state represents a state in which the signal input to the input terminal IN does not leak from the output terminal OUT, or a state in which the signal input to the input terminal IN is greatly attenuated (e.g., with an attenuation ratio of 100 dB or more).

With conventional techniques, in a case in which there is a desire to disconnect a signal path comprising such a step attenuator apparatus 1100, there is a need to provide a switch in series with the step attenuator apparatus 1100 for turning off the signal. Such a switch leads to an increased number of components, increased costs, and an increased circuit area, which is undesirable.

### SUMMARY OF THE INVENTION

The present invention has been made in view of such a situation. Accordingly, it is an exemplary purpose of an embodiment of the present invention to provide a step attenuator apparatus configured to provide a disconnected state without involving an external switch.

An embodiment of the present invention relates to a step attenuator apparatus configured to have an attenuation ratio which is switchable according to a control signal. The step attenuator apparatus comprises multiple variable attenuators connected in series. Each variable attenuator comprises a first terminal, a second terminal, multiple paths having different attenuation ratios, a first switch configured to be capable of connecting the first terminal to one end of a desired path selected from among the multiple paths, and a second switch configured to be capable of connecting the second terminal to the other end of a desired path selected from among the multiple paths.

Furthermore, the step attenuator apparatus comprises a control unit configured to control, according to the control signal, the first switch and the second switch included in each of the multiple variable attenuators. When the control signal is an instruction to set the step attenuator apparatus to a disconnected state, the control unit connects the first switch of the first-stage variable attenuator to one of the multiple paths, and connects the second switch of the first-stage variable attenuator a different one of the multiple paths.

With such an embodiment, the signal can be disconnected at the first-stage variable attenuator.

Also, when the control signal is an instruction to set the step attenuator apparatus to a disconnected state, the control unit may connect the first switch of the first-stage variable attenuator to a path having a non-zero attenuation ratio.

With such an arrangement, when a signal is input to the step attenuator apparatus in the disconnected state via the input terminal, the input signal is reflected after it makes one round trip through the first-stage variable attenuator. Thus, by setting the attenuation ratio of the first-stage variable attenuator to a high value in the disconnected state, such an arrangement provides reduced signal reflection.

Also, when the control signal is an instruction to set the step attenuator apparatus to a disconnected state, the control unit may connect the first switch of the first-stage variable attenuator to a path that has the highest attenuation ratio among the multiple paths.

Also, when the control unit receives an instruction to set the step attenuator apparatus to the disconnected state, the control unit may connect the first switch of the final-stage variable attenuator to a path selected from among the multiple paths, and may connect the second switch of the final-stage variable attenuator to a different path selected from among the multiple paths.

By configuring the final-stage variable attenuator in the same way as the first-stage variable attenuator, the path between the input terminal and the output terminal can be disconnected at two positions. Thus, such an arrangement provides improved isolation.

Also, when the control signal is an instruction to set the step attenuator apparatus to the disconnected state, the control unit may connect the second switch of the final-stage variable attenuator to a path that has the highest attenuation ratio among the multiple paths.

With such an arrangement, when a signal is input to the step attenuator apparatus in the disconnected state via the output terminal, the signal thus input is reflected after it makes one round trip through the final-stage variable attenuator. Thus, by setting the attenuation ratio of the final-stage variable attenuator to a high value in the disconnected state, such an arrangement provides reduced signal reflection.

Also, when the control signal is an instruction to set the step attenuator apparatus to the disconnected state, the control unit may connect the first switch of the first-stage variable attenuator to a path having an attenuation ratio of 5 dB or more, and may connect the second switch of the final-stage variable attenuator to a path having an attenuation ratio of 5 dB or more.

Such an arrangement provides a return loss of 10 dB or more on both the input terminal side and the output terminal side in the disconnected state.

Also, two variable attenuators that have the highest selectable attenuation ratios among the multiple variable attenuators may be respectively arranged as the first-stage attenuator and the final-stage attenuator.

Another embodiment of the present invention relates to a signal generator. The signal generator comprises the aforementioned step attenuator apparatus.

Yet another embodiment of the present invention relates to a test apparatus. The test apparatus comprises the aforementioned step attenuator apparatus.

By setting the step attenuator apparatus to the disconnected state, embodiments such as these provide a non-signal state in which the internal circuit configuration can be modified, and various processing can be performed.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram which shows a configuration of a typical step attenuator apparatus;

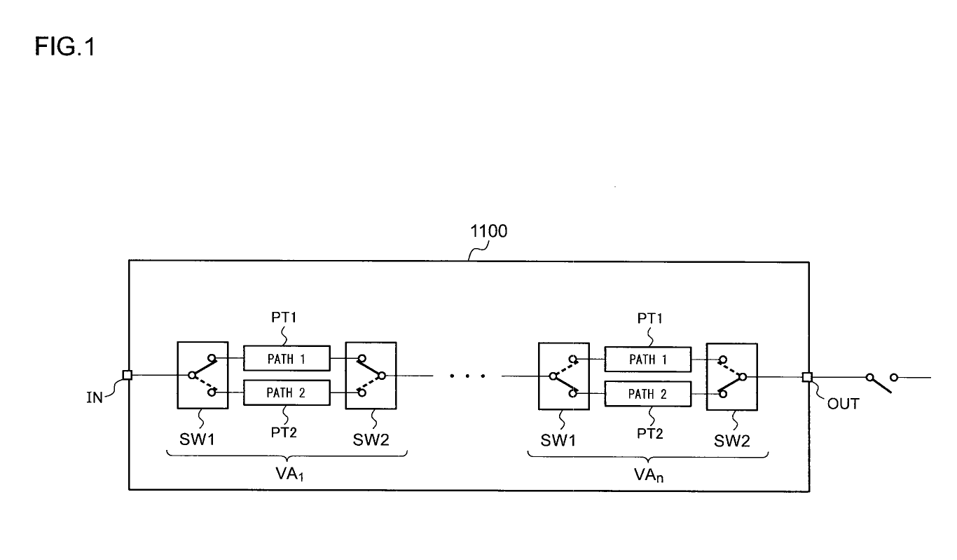

FIG. 2 is a circuit diagram which shows a configuration of a step attenuator apparatus according to an embodiment; and

FIGS. 3A and 3B are block diagrams respectively showing schematic configurations of a signal generator and a test apparatus each including the step attenuator apparatus shown in FIG. 2.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not substantially affect the electric connection therebetween, or that does not damage the functions or effects of the connection therebetween, in addition to a state in which the member A is physically and directly connected to the member B. Similarly, the state represented by the phrase “the member C is provided between the member A and the member B” includes a state in which the member A is indirectly connected to the member C, or the member B is indirectly connected to the member C via another member that does not substantially affect the electric connection therebetween, or that does not damage the functions or effects of the connection therebetween, in addition to a state in which the member A is directly connected to the member C, or the member B is directly connected to the member C.

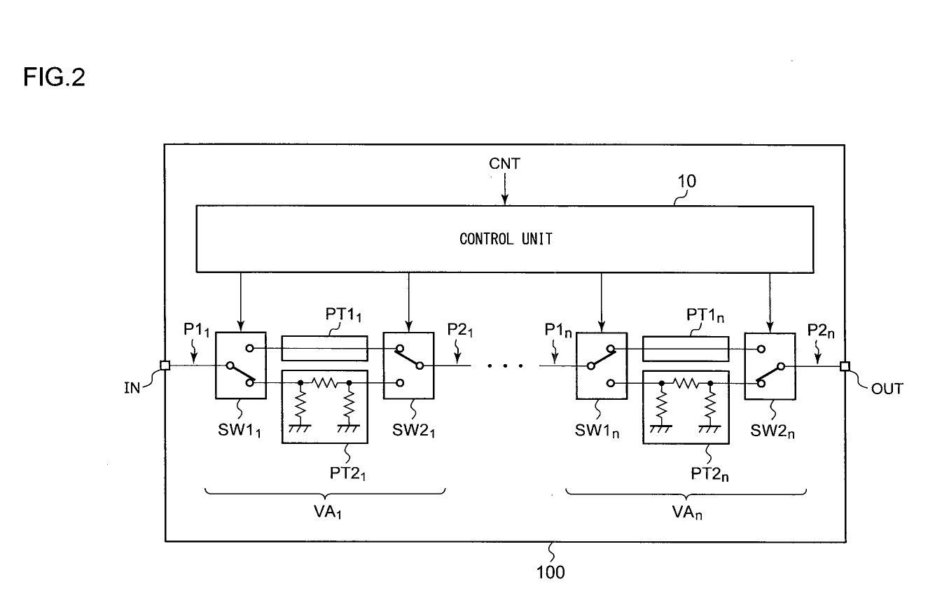

FIG. 2 is a circuit diagram which shows a configuration of a step attenuator apparatus 100 according to an embodiment. The step attenuator apparatus 100 is configured to allow the attenuation ratio of a path between the input terminal IN and the output terminal OUT to be switched according to a control signal CNT. The step attenuator apparatus 100 includes multiple variable attenuators VA₁ through VAₙ and a control unit 10. It should be noted that the “input terminal IN” and “output terminal OUT” are thus named for convenience of description. It is needless to say that the step attenuator apparatus 100 is capable of attenuating both a signal that propagates from the input terminal IN to the output terminal OUT and a signal that propagates from the output terminal OUT to the input terminal IN.

The variable attenuators VA₁ through VAₙ are sequentially connected in series between the input terminal IN and the output terminal OUT. The number of the n variable attenuators VA may be set to any integer that is two or greater.

Each variable attenuator VA includes a first terminal P1, a second terminal P2, multiple paths PT1 and PT2, a first switch SW1 and a second switch SW2. The multiple paths PT1 and PT2 have different respective attenuation ratios. For example, the first path PT1 has an attenuation ratio of 0 dB, and the second path PT2 has a non-zero attenuation ratio. Each path PT may be configured as a transmission line having an attenuation ratio that is substantially zero. Also, in a case in which the attenuation ratio is substantially non-zero, i.e., in a case in which the path PT has a significant attenuation ratio, the path PT may be configured as a T-type attenuator or a π-type attenuator. Alternatively, such a path PT may be configured as an attenuator having other configurations.

Also, the number of paths and the attenuation ratio of each path may be different for each variable attenuator VA.

The first switch SW1 is configured to be capable of connecting the first terminal P1 to one end of a desired path selected from among the multiple paths PT1 and PT2. The second switch SW2 is configured to be capable of connecting the second terminal P2 to the other end of a desired path selected from among the multiple paths PT1 and PT2. The first switch SW1 and the second switch SW2 may each be configured as a semiconductor switch, a relay switch, or a MEMS (Micro Electro Mechanical Systems).

The control unit 10 controls the first switch SW1 and the second switch SW2 of each of the multiple variable attenuators VA₁ through VAₙ according to the control signal CNT.

The step attenuator apparatus 100 according to the embodiment operates in two operating modes, i.e., a mode in which it functions as an ordinary attenuator and a mode in which it disconnects a path between the input terminal IN and the output terminal OUT. The control signal CNT functions as an instruction to switch the attenuation ratio in the attenuation mode, and as an instruction to switch the mode between the attenuation mode and the disconnect mode.

### [Attenuation Mode]

The control unit 10 selects one path PT for each of the variable attenuators VA₁ through VAₙ so as to provide an attenuation ratio that corresponds to the control signal CNT between the input terminal IN and the output terminal OUT. When the j-th path PTjᵢ is to be selected for the i-th variable attenuator VAᵢ, the control unit 10 connects the first switch SW1ᵢ to one end of the path PTjᵢ, and connects the second switch SW2ᵢ to the other end of the path PTjᵢ.

[Disconnect Mode]

When the control signal CNT is an instruction to set the step attenuator apparatus 100 to the disconnected state, the control unit 10 connects the first switch SW1₁ included in the first-stage variable attenuator VA₁ to one of the multiple paths thereof, and connects the second switch SW2₁ of the first-stage variable attenuator VA₁ to a different one of the other paths thereof. The state as described above in which the first switch SW1 and the second switch SW2 included in a particular variable attenuator VA are respectively connected to different paths will be referred to as the “disconnected state” in the present specification.

In the disconnect mode, the control unit 10 preferably connects the switch on the input terminal IN side included in the first-stage variable attenuator VA₁, i.e., the first switch SW1, to a path, selected from among the multiple paths PT1₁ and PT2₁, having a non-zero attenuation ratio, preferably having an attenuation ratio of 5 dB or more. Preferably, the control unit 10 connects the first switch SW1 to a path having the highest attenuation ratio among the multiple paths PT1₁ and PT12, (PT2₁ in an example shown in FIG. 2). In this case, the second switch SW2₁ is connected to the other path PT1₁.

Furthermore, in the disconnect mode, the control unit 10 connects the first switch SW1ₙ included in the final-stage variable attenuator VAₙ to one of the multiple paths PT1ₙ and PT2ₙ, and connects the second switch SW2ₙ of the final-stage variable attenuator VAₙ to a different one of the other paths thereof. When the control signal CNT is an instruction to set the step attenuator apparatus 100 to the disconnected state, the control unit 10 preferably connects the switch of the final-stage variable attenuator VAₙ connected to the output terminal OUT, i.e., the second switch SW2ₙ, to a path, selected from among the multiple paths PT1ₙ and PT2ₙ, having a non-zero attenuation ratio, and preferably having an attenuation ratio of 5 dB or more. Preferably, the control unit 10 connects the second switch SW2ₙ to a path having the highest attenuation ratio (PT2ₙ in an example shown in FIG. 2) from among the multiple paths PT1ₙ and PT2ₙ. In this case, the first switch SW1ₙ is connected to the other path PT1ₙ.

In the disconnect mode, the control unit 10 instructs each of the variable attenuators VAᵢ (i=2 to n−1) other than the first-stage attenuator and the final-stage attenuator to connect the first switch SW1ᵢ and the second switch SW2ᵢ to the same path PTjᵢ, in the same way as in the attenuation mode.

As described above, each of the variable attenuators VA₁ through VAₙ may have a different maximum settable attenuation ratio. For example, description will be made regarding the step attenuator apparatus 100 having five stages of such variable attenuators VA.

Let us consider an arrangement including five variable attenuators VA, respectively having maximum settable attenuation ratios of 20 dB, 20 dB, 20 dB, 10 dB, and 5 dB, which are arranged in series. The five variable attenuators VA may be arranged in a desired order assuming that only the attenuation mode is used.

In contrast, with the present embodiment, preferably, the two variable attenuators having the maximum selectable attenuation ratios, i.e., the variable attenuators VA each having an attenuation ratio of 20 dB, are respectively arranged as the first-stage attenuator and the final-stage attenuator, giving consideration to the disconnect mode. In other words, the first-stage variable attenuator VA₁ and the final-stage variable attenuator VAₙ each include a path having an attenuation ratio of 20 dB. In the disconnect mode, the input terminal IN and the output terminal OUT are each connected to respective paths having an attenuation ratio of 20 dB. It should be noted that the other variable attenuators VA respectively having attenuation ratios of 20 dB, 10 dB, and 5 dB, may be arranged giving consideration to other characteristics.

The above is the configuration of the step attenuator apparatus 100. Next, description will be made regarding the operation thereof.

### [Attenuation Mode]

The operation of the step attenuator apparatus 100 in the attenuation mode is the same as that of a typical step attenuator apparatus 100. Specifically, the control unit 10 connects the first switch SW1ᵢ and the second switch SW2ᵢ included in the i-th (1≦i≦n) variable attenuator VAᵢ to a path having an attenuation ratio of Xᵢ (dB) according to the control signal CNT. In this state, the overall attenuation ratio ATT of the step attenuator apparatus 100 is represented by ATT=X₁+X₂+ . . . , Xₙ.

### [Disconnect Mode]

When the control signal CNT is an instruction to set the step attenuator apparatus 100 to the disconnected state, the control unit 10 switches each of the switches as shown in FIG. 2. In this state, a path between the input terminal IN and the output terminal OUT is electrically disconnected at the first-stage variable attenuator VA₁. Furthermore, the path between the input terminal IN and the output terminal OUT is electrically disconnected at the final-stage variable attenuator VAₙ.

With the step attenuator apparatus 100 shown in FIG. 2, there is no need to provide an external switch connected to the step attenuator apparatus 100. Thus, such an arrangement reduces the number of components, the costs, and the circuit area.

In some cases, the switches SW1 and SW2 employed in the step attenuator apparatus 100 have a problem in that signal leakage occurs between the terminals even if they are not connected to each other. In order to solve such a problem, by setting the first-stage variable attenuator VA₁ and the final-stage variable attenuator VAₙ to the disconnected state, such an arrangement suppress leakage that occurs between the input terminal IN and the output terminal OUT. It should be noted that, in a case in which the switches SW1 and SW2 can each be configured as a switch that provides sufficiently small leakage between the terminals that are not connected to each other, only the first-stage attenuator or only the final-stage attenuator may be set to the disconnected state.

With the present embodiment, in the disconnect mode, the input terminal IN is connected to the path PT2₁ having a non-zero attenuation ratio. A signal input from an external circuit to the input terminal IN passes through the path PT2₁, reflects from the second switch SW2₁, and passes through the path PT2₁ again, following which the signal is output from the input terminal IN to the external circuit, thereby providing a large return loss. A practical value of return loss is 10 dB to 15 dB or more. Thus, by providing the path PT2₁ having an attenuation ratio of 5 dB or more, such an arrangement provides a return loss of 10 dB. Furthermore, by providing the path having an attenuation ratio of 20 dB, such an arrangement provides a return loss of 40 dB. Thus, such an arrangement provides a sufficient practical value of return loss.

Furthermore, in the disconnect mode, the output OUT is connected to the path PT2ₙ having a non-zero attenuation ratio in the same way as described above. Thus, such an arrangement provides the return loss on the output terminal OUT side. In a case in which a high-gain amplifier is connected to the output terminal OUT, in some cases, an output terminal OUT having insufficient return loss leads to a problem of oscillation in the amplifier. With the embodiment, by designing the circuit giving consideration not only to the return loss of the input terminal IN but also to the return loss of the output terminal OUT, such an arrangement provides improvement of the stability of a device or an apparatus mounting the step attenuator apparatus 100.

Furthermore, only two of the variable attenuators VA are switchable to the disconnected state, and the other variable attenuators VA should be controlled in the same way as in conventional techniques. Accordingly, to that extent, the configuration of the control unit 10 is comparatively not as complex as that with a configuration required to control a conventional step attenuator apparatus. Thus, the increase in the circuit area of the control unit 10 is negligible.

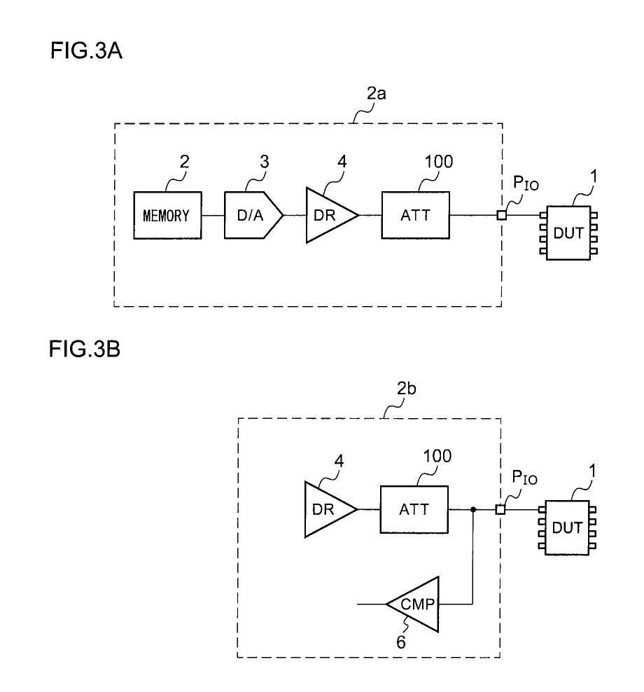

Next, description will be made regarding a suitable application of the step attenuator apparatus 100. FIGS. 3A and 3B are block diagrams respectively showing schematic configurations of a signal generator 2a and a test apparatus 2b each including the step attenuator apparatus 100 shown in FIG. 2.

The signal generator 2a shown in FIG. 3A includes waveform memory 2, a D/A converter 3, a driver 4, and a step attenuator apparatus 100. The D/A converter 3 reads out digital waveform data from the waveform memory 2, and converts the waveform data thus read out into an analog signal. The driver 4 amplifies the analog signal, and outputs the analog signal thus amplified to a DUT (device under test) 1 via an I/O pin P_{IO}.

The step attenuator apparatus 100 is arranged as a component downstream of the driver 4. In a normal operating state, the step attenuator apparatus 100 is set to the attenuation mode. In this state, by controlling the attenuation ratio, such an arrangement allows the signal level output from the I/O pin P_{IO} to be switched.

Furthermore, when an address in the waveform memory 2 is to be switched, or when the sampling frequency is to be changed, by setting the step attenuator apparatus 100 to the disconnect mode, such an arrangement prevents noise and unnecessary signals that occur at components upstream of the driver 4 from propagating to the DUT 1.

FIG. 3B shows an I/O unit which is a so-called pin electronics circuit provided to the test apparatus 2b. The step attenuator apparatus 100 is arranged as a component downstream of the driver 4. When a signal pattern is to be supplied to the DUT 1 from the driver 4, the step attenuator apparatus 100 is set to the attenuation mode. In this mode, such an arrangement is capable of switching the signal amplitude.

Furthermore, by setting the step attenuator apparatus 100 to the disconnect mode, such an arrangement prevents noise and unnecessary signals from propagating from the driver 4 to the DUT 1 or the comparator 6. Also, in a case in which a DC test is performed by means of a DC test unit (not shown) connected to the I/O pin P_{IO}, the step attenuator apparatus 100 should be set to the disconnect mode.

Description has been made regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

Description has been made in the embodiment regarding an arrangement in which the first-stage variable attenuator and the final-stage variable attenuator are each configured to be switchable to the disconnected state. However, the present invention is not restricted to such an arrangement. For example, only the first-stage variable attenuator or only the final-stage variable attenuator may be configured to be switchable to the disconnected state. Alternatively, any one of the intermediate-stage variable attenuators VA may be configured to be switchable to the disconnected state.

While the preferred embodiments of the present invention have been described using specific terms, such description is for illustrative purposes only, and it is to be understood that changes and variations may be made without departing from the spirit or scope of the appended claims.

What is claimed is:

1. A step attenuator apparatus configured to have an attenuation ratio which is switchable according to a control signal, the step attenuator apparatus comprising:
a plurality of variable attenuators connected in series, each of which comprises a first terminal, a second terminal, a plurality of paths having different attenuation ratios, a first switch configured to be capable of connecting the first terminal to one end of a desired path selected from among the plurality of paths, and a second switch configured to be capable of connecting the second terminal to the other end of a desired path selected from among the plurality of paths; and
a control unit configured to control, according to the control signal, the first switch and the second switch included in each of the plurality of variable attenuators,
wherein, when the control signal is an instruction to set the step attenuator apparatus to a disconnected state, the control unit connects the first switch of the first-stage variable attenuator to one of the plurality of paths, and connects the second switch of the first-stage variable attenuator a different one of the plurality of paths.

2. A step attenuator apparatus according to claim 1, wherein, when the control signal is an instruction to set the step attenuator apparatus to a disconnected state, the control unit connects the first switch of the first-stage variable attenuator to a path having a non-zero attenuation ratio.

3. A step attenuator apparatus according to claim 2, wherein, when the control signal is an instruction to set the step attenuator apparatus to a disconnected state, the control unit connects the first switch of the first-stage variable attenuator to a path that has the highest attenuation ratio among the plurality of paths.

4. A step attenuator apparatus according to claim 1, wherein, when the control unit receives an instruction to set the step attenuator apparatus to the disconnected state, the control unit connects the first switch of the final-stage variable attenuator to a path selected from among the plurality of paths, and connects the second switch of the final-stage variable attenuator to a different path selected from among the plurality of paths.

5. A step attenuator apparatus according to claim 2, wherein, when the control unit receives an instruction to set the step attenuator apparatus to the disconnected state, the control unit connects the first switch of the final-stage variable attenuator to a path selected from among the plurality of paths, and connects the second switch of the final-stage variable attenuator to a different path selected from among the plurality of paths.

6. A step attenuator apparatus according to claim 3, wherein, when the control unit receives an instruction to set the step attenuator apparatus to the disconnected state, the control unit connects the first switch of the final-stage variable attenuator to a path selected from among the plurality of paths, and connects the second switch of the final-stage variable attenuator to a different path selected from among the plurality of paths.

7. A step attenuator apparatus according to claim 4, wherein, when the control signal is an instruction to set the step attenuator apparatus to the disconnected state, the control unit connects the second switch of the final-stage variable attenuator to a path having a non-zero attenuation ratio.

8. A step attenuator apparatus according to claim 5, wherein, when the control signal is an instruction to set the step attenuator apparatus to the disconnected state, the control unit connects the second switch of the final-stage variable attenuator to a path having a non-zero attenuation ratio.

9. A step attenuator apparatus according to claim 6, wherein, when the control signal is an instruction to set the step attenuator apparatus to the disconnected state, the control unit connects the second switch of the final-stage variable attenuator to a path having a non-zero attenuation ratio.

10. A step attenuator apparatus according to claim 7, wherein, when the control signal is an instruction to set the step attenuator apparatus to the disconnected state, the control unit connects the second switch of the final-stage variable attenuator to a path that has the highest attenuation ratio among the plurality of paths.

11. A step attenuator apparatus according to claim 8, wherein, when the control signal is an instruction to set the step attenuator apparatus to the disconnected state, the control unit connects the second switch of the final-stage variable attenuator to a path that has the highest attenuation ratio among the plurality of paths.

12. A step attenuator apparatus according to claim 9, wherein, when the control signal is an instruction to set the step attenuator apparatus to the disconnected state, the control unit connects the second switch of the final-stage variable attenuator to a path that has the highest attenuation ratio among the plurality of paths.

13. A step attenuator apparatus according to claim 1, wherein, when the control signal is an instruction to set the step attenuator apparatus to the disconnected state, the control unit connects the first switch of the first-stage variable attenuator to a path having an attenuation ratio of 5 dB or more, and connects the second switch of the final-stage variable attenuator to a path having an attenuation ratio of 5 dB or more.

14. A step attenuator apparatus according to claim 1, wherein two variable attenuators that have the highest selectable attenuation ratios among the plurality of variable attenuators are respectively arranged as the first-stage attenuator and the final-stage attenuator.

15. A signal generator comprising a step attenuator apparatus configured to have an attenuation ratio which is switchable according to a control signal, wherein the step attenuator comprises:
a plurality of variable attenuators connected in series, each of which comprises a first terminal, a second terminal, a plurality of paths having different attenuation ratios, a first switch configured to be capable of connecting the first terminal to one end of a desired path selected from among the plurality of paths, and a second switch configured to be capable of connecting the second terminal to the other end of a desired path selected from among the plurality of paths; and
a control unit configured to control, according to the control signal, the first switch and the second switch included in each of the plurality of variable attenuators,
wherein, when the control signal is an instruction to set the step attenuator apparatus to a disconnected state, the control unit connects the first switch of the first-stage variable attenuator to one of the plurality of paths, and connects the second switch of the first-stage variable attenuator a different one of the plurality of paths.

16. A test apparatus comprising a step attenuator apparatus configured to have an attenuation ratio which is switchable according to a control signal, wherein the step attenuator comprises:
a plurality of variable attenuators connected in series, each of which comprises a first terminal, a second terminal, a plurality of paths having different attenuation ratios, a first switch configured to be capable of connecting the first terminal to one end of a desired path selected from among the plurality of paths, and a second switch configured to be capable of connecting the second terminal to the other end of a desired path selected from among the plurality of paths; and
a control unit configured to control, according to the control signal, the first switch and the second switch included in each of the plurality of variable attenuators,
wherein, when the control signal is an instruction to set the step attenuator apparatus to a disconnected state, the control unit connects the first switch of the first-stage variable attenuator to one of the plurality of paths, and connects the second switch of the first-stage variable attenuator a different one of the plurality of paths.
